(19) United States
(12) Patent Application Publication
(10) Pub. No.: US 2010/0029293 A1
(43) Pub. Date: Feb. 4, 2010

(54) NAVIGATION SYSTEM USING CAMERA

(75) Inventors: Jonas Bergh, Kavlinge (SE); Sebastian Wallin, Lund (SE)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communications AB, Lund (SE)

(21) Appl. No.: 11/747,035

(22) Filed: May 10, 2007

(51) Int. Cl. H04W 4/02; G01C 21/36

(52) U.S. Cl. 455/456.1; 701/207; 701/201

(57) ABSTRACT

The present invention provides a method, a computer program, and device for navigation assistance where the method and the computer program may include receiving location information related to the geographical location of a device for navigation assistance, continuously receiving visual information registered by a camera, displaying the visual information received, calculating the geographical coordinates of the device from the received location information related to the geographical location of the device and analyzing the visual information received and relating it to the calculated geographical location of the device.

### TECHNICAL FIELD

The present invention generally relates to navigation devices and systems.

### BACKGROUND

Geographic position determination using the Global Positioning System (GPS) has become a widely-used positioning technology. In typical GPS systems, position coordinates relative to the earth's surface are determined by sending timing and orbital coordinates from at least three geostationary satellites to a receiver of a GPS-enabled device. By correcting the clock of the GPS receiver using clock synchronization signals from the three satellites plus a clock error correction signal from a fourth geostationary satellite, the position of the GPS-enabled device can be determined with great precision and accuracy. The same holds true for GPS receivers that are moving, such as those used in motor vehicles, boats, aircraft, or even on persons using, for example, a handheld GPS receiver.

A variety of commercially-available GPS navigation equipment exists, from simple hand-held GPS receivers displaying coordinates and direction of movement, to more advanced GPS receivers that render information via maps of entire regions with streets, roads, freeways, hotels, points of interest, etc. The latter category, in particular, is commonly used in motor vehicles as built-in GPS navigation systems or as separate GPS navigation devices. Such GPS navigation devices are increasingly used on motorcycles, bicycles, or as mobile GPS navigation devices. For a number of years, personal digital assistants (PDAs) and so called, smartphones, equipped with GPS navigation software and GPS receivers have been in use.

In such systems, the position of the GPS navigation device is determined by triangulation and by mapping geographical coordinates of the GPS navigation device with reference to a provided street or geographical map. In GPS navigation devices and mobile terminals equipped with GPS receivers and appropriate mapping software, however, it may prove difficult for a user to relate the schematic street map rendered by the GPS navigation device to actual buildings and streets as viewed by the user, since most maps for GPS navigation devices are simplified two- (e.g., plan view) or quasi-three-dimensional representations of the terrain.

Ease of use of such devices becomes more of a challenge to achieve when the user is simultaneously operating a motor vehicle and navigating using the GPS navigation device, since the driver still has to compare the displayed map to the actual streets and buildings encountered by the user. For example, frequently referring to the map on the GPS navigation device may distract the driver from concentrating on operation of the vehicle and thereby pose a potential safety hazard. In addition, such practices may lead the driver to miss a turn or exit and therefore required backtracking or alternative routing and, possibly, result in a less direct path to the desired driving destination.

### SUMMARY

Embodiments of the present invention may be implemented in a device for navigation assistance that includes at least one receiver for receiving location information related to the geographical location of the device, the device being arranged to continuously receive visual information registered by a camera, and a display for displaying the visual information received, the device further including a memory for storing location information related to the region or area through which the device is moving and a processing unit for continuously calculating the geographical coordinates of the device from the location information related to the geographical location of the device, where the processing unit is arranged to continuously analyze the visual information received from the camera and to relate it to the information indicative of the geographical location of the device.

Advantages of such a device include a driver being able to readily relate the surrounding scenery to the real world in the moving direction to thereby avoid confusion when following directions provided from such a navigation system.

According to another aspect of the present invention, a device for navigation assistance including at least one receiver for receiving location information related to the geographical location of the device, the device being arranged to intermittently receive visual information registered by a camera, and a display for displaying the visual information received, the device further includes a memory for storing location information related to the region or area through which the device is moving and a processing unit for intermittently calculating the geographical coordinates of the device from the location information related to the geographical location of the device, where the processing unit is arranged to intermittently analyze the visual information received from the camera and to relate it to the information indicative of the geographical location of the device.

Advantages of such a device include a device configured to register the scenery in the moving direction of the device at random time instants selected by the user of the device.

According to yet another aspect of the present invention, a system for navigation assistance including at least one receiver for receiving location information related to the geographical location of the receiver, a camera for registering visual information in the direction in front of the camera, a display in communication with the camera for displaying the visual information registered by the camera, the system further includes a memory for storing location information related to the vicinity through which the receiver is moving and a processing unit in communication with the memory for continuously calculating the geographical coordinates of the receiver from the location information related to the geographical location of the receiver, where the processing unit is further in communication with the camera and arranged to continuously analyze the visual information received from the camera and to relate it to the information indicative of the geographical location of the receiver.

Advantages of such a device include having separate components communicating with each other and essentially performing the same function as the device for the above-described navigation assistance. Making the components separate would lead to more freedom of choice regarding the processing power, storage capacity, and complexity of the receiver in the system.

According to yet another aspect of the present invention, a method for navigation assistance includes:

a) receiving location information related to the geographical location of a device for navigation assistance;
b) continuously receiving visual information registered by a camera;
c) displaying the visual information received;
d) calculating the geographical coordinates of the device from the received location information related to the geographical location of the device; and
e) continuously analyzing the visual information received and relating it to the calculated geographical location of the device.

A method according to the present invention is well suited to be implemented by above-described devices or systems for navigation assistance.

Further, according to another aspect of the present invention, a computer program for navigation assistance includes instruction sets for:

a) continuously receiving location information related to the geographical location of a device for navigation assistance;
b) receiving visual information registered by a camera;
c) displaying the visual information received;
d) calculating the geographical coordinates of the device from the received location information related to the geographical location of the device; and
e) continuously analyzing the visual information received and relating it to the calculated geographical location of the device.

The above-described computer program may be well suited to execute the steps of the method according to the present invention and to be executed in a device or system according to the present invention.

These and other advantages of the present invention will be more readily apparent by studying the following detailed description together with the accompanying drawings.

### BRIEF DESCRIPTION OF THE DRAWINGS

The accompanying drawings, which are incorporated in and constitute a part of the specification, illustrate an embodiment of the invention and, together with the description, explain implementations of the invention. In the drawings,

FIG. 1 illustrates an exemplary satellite navigation device for use in a motor vehicle;

FIG. 2 illustrates an exemplary satellite navigation device in which systems and methods of the invention may be implemented;

FIG. 3 is a schematic of functional components of a satellite navigation device in which systems and methods of the invention may be implemented; and

FIG. 4 illustrates exemplary steps of a invention which may be implemented in a satellite navigation system.

### DETAILED DESCRIPTION

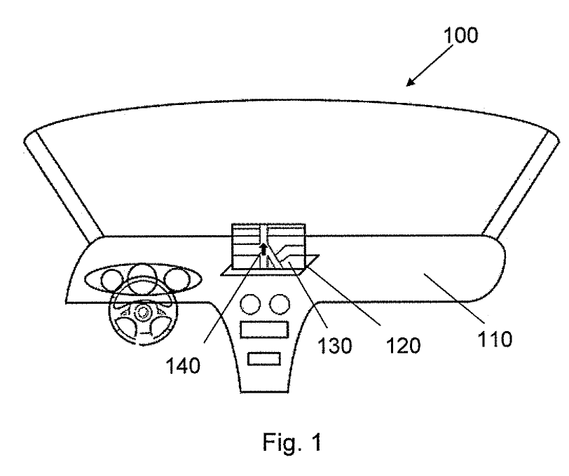

FIG. 1 schematically illustrates a passenger compartment 100 of a (“host”) vehicle equipped with a GPS (Global Positioning System) navigation device 120 and attached to a dashboard or instrument panel 110 of the vehicle. It is possible for GPS navigation device 120 to be built-in into the vehicle, for example, integral in the instrument panel of the vehicle (not shown).

GPS navigation device 120 may, via a GPS receiver circuit, which may be external to or built-in GPS navigation device, intermittently communicate with at least three geostationary satellites (not shown). Out of the at least three satellites, three satellites may be used to determine the position of the vehicle down to a certain area, while data from a fourth satellite (clock data) may be used to locate the position of the vehicle down to, for example, a few meters, while at the same time determining the velocity of the vehicle.

Each of the four satellites may transmit respective orbital coordinates, which may, together with the velocity and the position of the vehicle, be used to locate the vehicle within a coordinate system associated with the earth's surface. Together with the “terrestrial” coordinates and software inside GPS navigation device 120, the position of the vehicle in relation to the city or region through which the vehicle is traveling, may be determined and representatively displayed. The representation may be rendered via display 130 of the GPS navigation device 120.

While the vehicle is moving on a street or freeway, its (direction of) movement may be representatively indicated by an arrow 140 or similar symbol on display 130 of GPS navigation device 120.

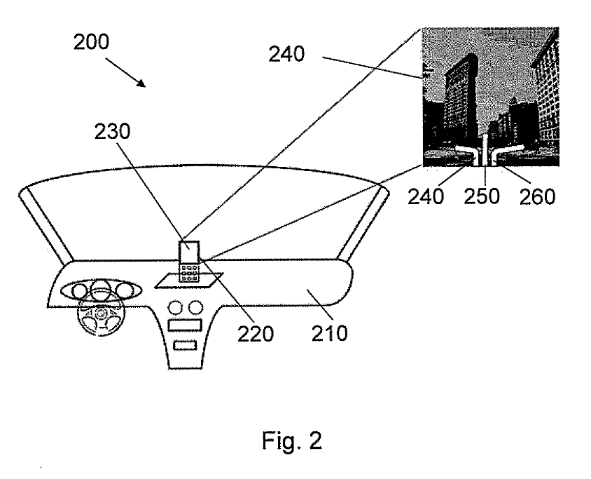

FIG. 2 illustrates a satellite navigation system 200 in a vehicle according to one embodiment of the present invention. However, it will be appreciated that satellite navigation system 200 may equally be used in other modes of transportation, e.g., not equipped with engines, such as bicycles or the like.

It should also be noted here that the present invention is not limited to a satellite navigation system only, but may also be used in a wireless communication network, such as a GSM (Globals System for Mobile telephony), UMTS (Universal Mobile Telephony System), HSPDA (High-Speed Packet Data Access), IEEE 802.11 series (a, b, g, n), HiperLAN, WiMAX, and other wireless communication networks capable of localizing a mobile terminal using triangulation data in the wireless communication network.

Also, it may be pointed out here that the term mobile terminal should be interpreted as referring to any device operable in a communication network and including at least a receiver as well as being transportable, i.e., being portable or movable.

Returning now to FIG. 2, a mobile terminal 220 is shown to be attached to the upper part of a dashboard or instrument panel 210 of the vehicle. On a display 230 of mobile terminal 220, the view from its camera unit (not shown) may be shown in an enlarged view 240. Assume that the camera of mobile terminal 220 is essentially directed towards the driving direction of the vehicle and that display 230 shows the view registered from the camera of mobile terminal 220 substantially in real time. Hence, display 230 of mobile terminal 220 may be referred to as viewfinder 230 in the following description.

It should be mentioned here that mobile terminal 220 should be disposed on instrument panel 210 of the vehicle in such a way that the camera is able to register the surroundings to the fore of the vehicle in the driving direction of the vehicle.

Mobile terminal 220 may be equipped with satellite navigation software and a satellite signal receiver (not shown) that may be configured to receive positioning signals, i.e., synchronization patterns for clock synchronization and orbital coordinates from at least three geostationary satellites, the details of which need not be presented herein. The satellite navigation software may allow the user, e.g., the driver of the vehicle, to specify a desired destination, and possibly preferred route(s). The satellite navigation software, according to the present invention, may also have the ability to continuously analyze images rendered in viewfinder 230 of the camera arrangement and, by using pattern recognition algorithms or the like, separate primary objects, such as streets, roads, highways, waterways, and other thoroughfares from secondary objects, such as buildings, trees, and other landmarks.

The term, continuously, in the preceding paragraph and in the following description herein, should be understood as occurring in certain time intervals that need not be constant and may range, for example, from milliseconds, seconds, or longer periods of time.

Calculating geographical coordinates for the host vehicle based on timing signals and orbital coordinates received from the at least three geostationary satellites and mapping of the geographical coordinates on the processed image captured via the camera arrangement may enable identification of the position of the vehicle relative to the street on which it may be currently traveling. Mapping may be performed continuously. The software may superpose arrows or other directional indicators on the moving image or video rendered in viewfinder 230 to indicate the direction in which the vehicle should proceed to reach the predetermined destination.

In one implementation, a single arrow at a time is displayed in viewfinder 230 of the camera unit, so multiple arrows 240, 250 and 260 superposed on the image shown on display 230 of the mobile terminal 220 are for illustrative purposes.

The directional indicators (e.g., arrows 240, 250, 260) may have any form or shape suitable to indicate to the user the appropriate direction of travel. In one implementation, the directional indicators (e.g., arrows 240, 250, 260) may correspond to contours of the streets, roads, and highways to facilitate identification of an upcoming driving direction (e.g., turn, maneuver, etc.).

In this regard, the operator of the vehicle may readily follow the route entered or specified in the satellite navigation software of mobile terminal 220. That is, the driver need not frequently compare the actual streets and buildings to that which is represented via display 230 of mobile terminal 220.

While a standard scheme for calculating the geographical position of a mobile terminal has been described prior to the image processing performed by the satellite software, according to the present invention, the calculation of the geographical position may be accomplished, differently, where the navigation is performed in a wireless communication network, such as a GSM, UMTS, HPSDA, IEEE 802.11 series (a, b, g, n), HyperLAN, WiMAX, or other wireless communication networks. While in mobile communication networks, such as GSM, UMTS, and HPSDA, the position determination may be based on triangulation using signal strength and timing information from mobile terminal 220, in other wireless communication networks, such as IEEE 802.11 series (a, b, g, n), HyperLAN, WiMAX, or the like, it may be based on a combination of parameters, such as attenuation, reflection and multi-path characteristics for signals transmitted by mobile terminal 220 and received at three or more access points of the wireless communication network. Both cases presuppose, for example, that mobile terminal 220 includes a transmitter (e.g., a transceiver).

It may also be possible to provide the host vehicle with a built-in mobile terminal 220, where the camera arrangement is located apart from mobile terminal 220 so as to be able to optimally register the scenery in a driving direction of the vehicle. For example, the camera arrangement may be provided inside passenger compartment 200 of the vehicle in a position to be able to register the scenery in the driving direction of the vehicle. The camera arrangement may be positioned outside passenger compartment 200 of the vehicle, for example, in a fore section of the vehicle, such as in the grill, hub, or anterior to the front window. In any case, display 230 of mobile terminal 220 may serve as viewfinder 240 for the camera arrangement and display the scenery in the driving direction of the vehicle as captured by the camera arrangement.

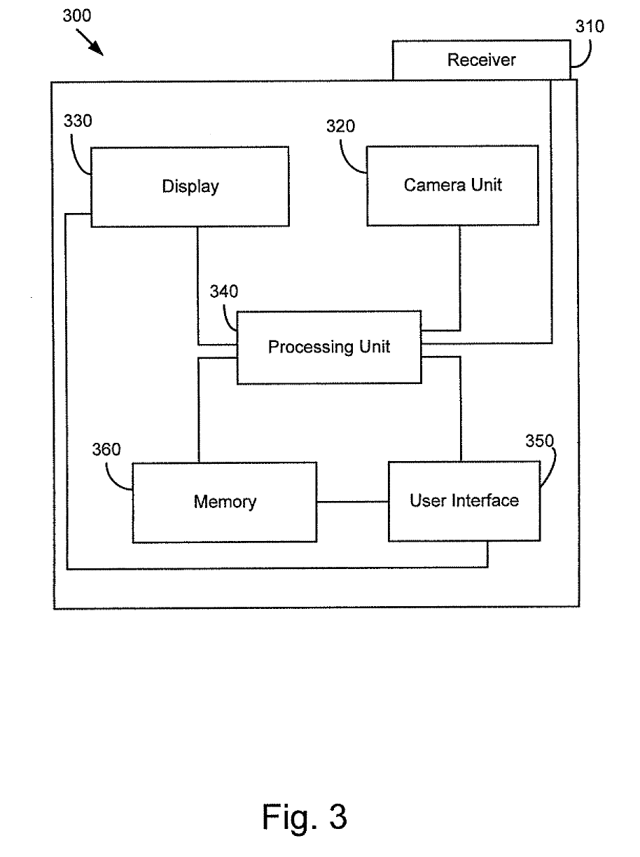

FIG. 3 is a schematic illustration of functional components of a mobile terminal or satellite navigation device 300, according to an embodiment of the present invention.

Illustratively, satellite navigation device 300 may include a receiver 310 for receiving satellite signals from at least three geostationary satellites, which signals may include clock synchronization signals for synchronizing the clock in receiver 310 with the clocks in the geostationary satellites. Satellite navigation device 300 may receive orbital coordinates from the at least three geostationary satellites at receiver 310 to map its coordinates to coordinates on the earth's surface.

Satellite navigation device 300 may, for example, include a transmitter (not shown) when satellite navigation device 300 is configured for use as a communication device, for instance, in wireless communication networks, for example, when satellite receiver 310 resides in a mobile terminal, such as a cell phone, PDA, laptop, or some other type of mobile terminal.

Furthermore, satellite navigation device 300 may include a camera unit 320 configured to capture still (e.g., photographs) and/or video images. The functions of camera unit 320 and operating parameters need not be described in detail herein. It suffices to say that essentially the resolution of cameras built into current cell phones, PDA:s, or palmtops, for example, is sufficient for implementations of the present invention.

Camera unit 320 may connect to (e.g., transmit and/or receive signals from) display 330, which, apart from having the function of a viewfinder for camera unit 320, may be used to display other information unassociated with camera unit 320, such as icons, menus, and other information associated with other functionality of satellite navigation device 300.

Additionally, camera unit 320 may connect to a processing unit 340 that may be configured to analyze visual information registered by camera unit's 320 sensor (not shown) and to map location information for the vehicle calculated from timing and coordinates provided by the at least four geostationary satellites onto the visual information displayed on viewfinder 330. Processing unit 340 may be configured to identify and/or separate secondary objects, such as buildings, the horizon and other irrelevant objects from relevant objects, i.e. primary objects, such as streets, thoroughfares, and the like, and by mapping the extracted street data from the visual information to relevant local or regional maps stored in a memory storage 360 of satellite navigation device 300. In one implementation, satellite navigation device 300 may include a transmitter, the local and/or regional maps may also be located on a server belonging to a satellite navigation service provider. Implementations may allow the design of satellite navigation device 300 and the software stored in a storage device, such as a memory storage 360 of satellite navigation unit 300, to have a noncomplex structure. Implementations may allow the user of satellite navigation device 300 to have access to the most recent local and/or regional map information, since the update of the maps may be accomplished in one or a few centralized locations associated with the satellite navigation service provider.

Satellite navigation device 300 may include a user interface 350 that may, for example, provide the driver with the possibility of entering a driving route, e.g., from a starting point to a destination, or only to a destination point, as well as other types of information. In one implementation, user interface 350 may also provide the user with a choice of different local and/or regional maps which may be stored in memory storage 360 in satellite navigation device 300. User interface 350 may include one or more types of input mechanisms configured to receive user input, e.g., audible, tactile, mechanical, and/or other type of input.

Thus, when a destination is entered, for example, via user interface 350, processing unit 340 may map the coordinates of the vehicle (satellite navigation device 300) to the visual information registered by camera unit 320 and displays at least the next direction to drive via viewfinder 330 by a direction indicator, such as an arrow or similar indicator by comparing the location of the vehicle with the local and/or regional maps stored in memory storage 360 of satellite navigation device 300.

Satellite navigation unit 300 may be configured to provide the driver of the vehicle with the function of switching among various different views on viewfinder 330 of camera unit 320, e.g., direction arrows superposed onto the visual information displayed in camera viewfinder 330, the local and/or regional satellite navigation map view and/or direction arrows, together with distance and speed data displayed onto the visual information rendered via viewfinder 330. Implementations may allow the driver of the vehicle to get oriented using the satellite navigation map about places to frequent, places of interest, etc.

It will be appreciated that processing unit 340 may include an ASIC circuit and/or a standard processor using image processing software stored in memory storage 360 of satellite navigation device 300 when performing image processing and coordinate mapping operations. The image processing and navigation software may also be available for download as a software program from a server facility located in a wireless or wired communication network.

In some implementations, various components of satellite navigation device 300, such as camera unit 320, display 330, processing unit 340, user interface 350, and/or memory storage 360 may be integrated into satellite navigation device 300.

In some implementations, satellite navigation device 300, as a system, may include components, such as camera unit 320, display 330, processing unit 340, user interface 350, and/or memory storage 360 as separate units configured to communicate with others of the components, for example, wireless links and/or by wired links, such as using CAN bas, for example.

In some implementations, receiver 310 may be located in any suitable location inside or outside the passenger compartment of a vehicle, while display 330 may be built-in into the instrument panel and/or dashboard of the vehicle or in some other position in the passenger compartment which is readily visible by the driver and/or a passenger(s). Processing unit 340 may be located as a separate unit in the instrument panel and/or dashboard of the vehicle, in the rear part of the vehicle, in the trunk or some of suitable part of the vehicle. User interface 350 may either be built-in into display 330 (e.g., a touch-sensitive display) and/or be associated with the instrument panel. In some implementations, user interface 350 may be part of the button commands located on and/or near the steering device of the vehicle.

In some implementations, memory storage 360 may be located apart from one or more of the other units of satellite navigation device 300, for example, in the instrument panel or in the trunk of the vehicle.

Providing the different units of satellite navigation device 300 as individual components may have an advantage of being able to construct such a navigation system with customized processing power, storage space, display capabilities, and/or camera arrangements, and not be limited by space constraints compared to a system in which components are integrated into satellite navigation device 300.

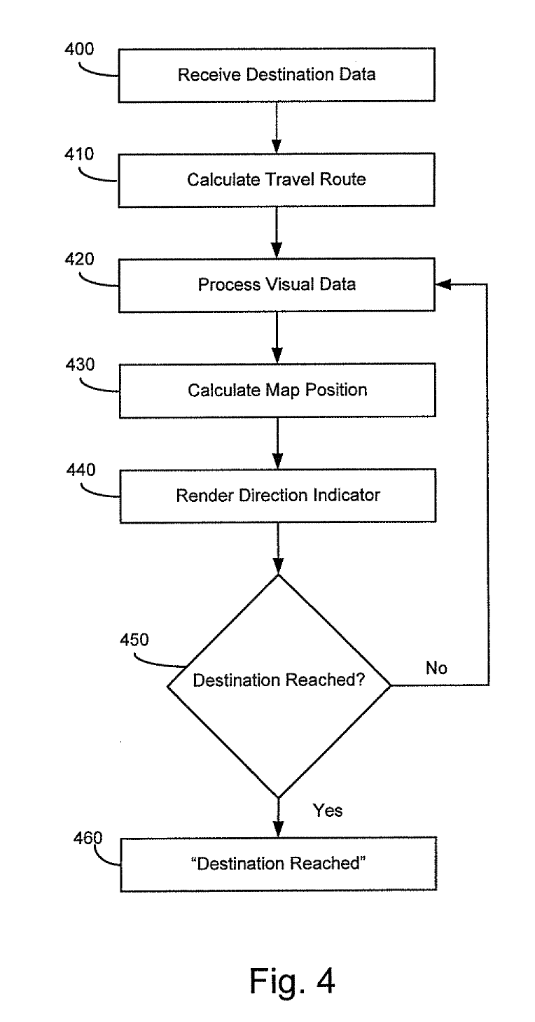

Referring now to FIG. 4, exemplary steps according to one embodiment of the present invention are illustrated in the form of a flowchart. Assume that the geographic location of the vehicle has already been determined by the satellite navigation system.

At step 400, a driver of the vehicle equipped with a mobile terminal, such as a satellite navigation system, may enter destination data using a user interface which is received at the satellite navigation device.

At step, 410, a processing unit in the satellite navigation device may calculate the satellite coordinates of the vehicle using information from geostationary satellites received at the satellite navigation device's receiver. The processing unit may calculate coordinates continuously throughout travel. The coordinates of the destination may be searched in a map database of the satellite navigation device and/or on a server of the satellite navigation service provider and the geographical coordinates of the destination may be stored in the memory storage or another storage device associated with the satellite navigation device. The processing unit may calculate a (e.g., shortest) driving route that connects the data points (e.g., starting point, current location, destination, etc.).

At step 420, the processing unit may analyze the visual information from the image sensor of the satellite navigation device's camera unit and perform image processing on the acquired visual data. The image processing may involve image processing algorithms for determining relevant data from the visual information, such as primary objects in the form of streets, crossings, freeways, while distinguishing (e.g., discarding) other secondary objects, such as the sky, buildings, other vehicles and other objects deemed not relevant for the formulation of driving directions.

Techniques of image processing may include histogram analysis and/or radon transformation, for example. Using these or similar technologies, for example, one can divide the visual information into distinct intensity segments and utilize the fact that the intensity distribution for a street or thoroughfare differs from the intensity distribution of other objects (e.g., a detectable difference in contrast between the road and the surroundings), such as buildings, other vehicles, the sky and the like. The radon transformation technology may detect the direction from which radiation emanates. For example, radiation from below combined with histogram analysis will more accurately distinguish roads from other objects in the driving direction of the vehicle.

At step 430, the processing unit may retrieve timing and orbital data from the satellite navigation device's receiver and calculate the position of the vehicle. Based on the timing and orbital data, and retrieved map data for the actual location from the memory storage, the processing unit may calculate the position of the vehicle on the map and compare position information to the streets or highways identified from the sensor data.

At step 440, the processing unit may calculate the travel directions corresponding to a predetermined route to the destination specified by the user, and map via the user interface arrows or other direction indicators onto the viewfinder of the satellite navigation device camera. In one implementation, the direction indicators may correspond to the contours of the ground on which the vehicle travels to aid the driver. The mapping of direction indicators may also be accompanied by spoken driving directions, if desired.

In some implementations, the processing unit may, via the user interface, for example, render graphical guiding lines or other visual effects (e.g., highlighting) to delineate or otherwise identify the streets or thoroughfares on route to the destination.

At step 450, the satellite navigation device may check the coordinates of the vehicle match against the coordinates of the specified destination. When the coordinates do not match, the satellite navigation device may return to step 420 and analyze the information retrieved from the satellite navigation device camera and map driving directions onto the display of the satellite navigation device. When the satellite navigation device determines that the satellite coordinates of the vehicle match the destination coordinates, the satellite navigation device may, at step 460 indicate, to the user on the display that the desired destination has been reached.

It should be clear to the person skilled in the art from the above elaboration that various modifications of the invention are possible within of the present invention as defined by the accompanying claims.

For example, the navigation device according to the present invention may also be used on a bicycle or by a pedestrian, for example, as the camera of the navigation device may be directed in the cycling or walking direction.

During use of the navigation device by a pedestrian, it may be possible to intermittently register the scenery in the walking direction by taking pictures of the scenery and having it analyzed by the processing unit, such as the processing unit 340, of the navigation device. Thereafter, the processing unit may after some image processing and mapping of the extracted primary objects to the geographical map in the memory of the navigation device display the next direction to take to guide the user to the specified destination.

What is claimed is:

1. A device for navigation assistance comprising at least one receiver for receiving location information related to the geographical location of the device, the device being arranged to continuously receive visual information registered by a camera, and a display for displaying the visual information received, the device further comprising a memory for storing location information related to the region or area through which the device is moving and a processing unit for continuously calculating the geographical coordinates of the device from the location information related to the geographical location of the device, wherein the processing unit is arranged to continuously analyze the visual information received from the camera and to relate it to the information indicative of the geographical location of the device.

2. The device of claim 1, wherein the device for navigation is built-in into a motor vehicle.

3. The device of claim 1, wherein the device for navigation comprises a mobile phone.

4. The device of claim 1, wherein the device additionally comprises a transmitter for communication with access points or base stations in a wireless communication network.

5. The device of claim 1, wherein the visual information registered by a camera comprises scenery in the direction of movement of the device.

6. The device of claim 1, wherein the camera is integrated with the device.

7. The device of claim 1, wherein the viewfinder is additionally arranged to display information comprising speed, geographical coordinates, distance to destination and geographical map of the area surrounding the geographical coordinates of the device.

8. The device of claim 1, wherein the device further comprises a user interface for permitting a user of the device to specify a geographical destination he intends to reach in the device.

9. The device of claim 1, wherein the processing unit is further arranged to distinguish primary objects, such as paths, streets, roads or freeways from other secondary objects, such as buildings, trees and the like in the visual information registered by a camera to extract these primary objects from the visual information.

10. The device of claim 1, wherein the memory is arranged to store geographical maps of the area or region of the geographical coordinates for the device.

11. The device of claim 9, wherein the processing unit is arranged to, using the calculated geographical coordinates for the device, map the extracted primary objects to a corresponding object of the geographical map.

12. The device of claim 1, wherein the processing unit is arranged to, based on the calculated geographical coordinates for the device and the geographical coordinates for the destination, calculate the next movement direction for the user and to indicate that direction by a direction indicator on the display of the device.

13. The device of claim 1, wherein the navigation is performed in a global satellite navigation system, such as satellite (Global Positioning System), Galileo or GLONASS (Global Navigation Satellite System).

14. The device of claim 1, wherein the navigation is performed in a wireless communication network, such as a GSM (Global System for Mobile telephony), UMTS (Universal Mobile Telephony System), IEEE 802.11 series (a, b, g, n) or some other wireless communication network capable of locating a mobile terminal.

15. A device for navigation assistance comprising at least one receiver for receiving location information related to the geographical location of the device, the device being arranged to intermittently receive visual information registered by a camera, and a display for displaying the visual information received, the device further comprising a memory for storing location information related to the region or area through which the device is moving and a processing unit for intermittently calculating the geographical coordinates of the device from the location information related to the geographical location of the device, wherein the processing unit is arranged to intermittently analyze the visual information received from the camera and to relate it to the information indicative of the geographical location of the device.

16. A system for navigation assistance comprising at least one receiver for receiving location information related to the geographical location of the receiver, a camera for registering visual information in the direction in front of the camera, a display in communication with the camera for displaying the visual information registered by the camera, the system further comprising a memory for storing location information related to the region or area through which the receiver is moving and a processing unit in communication with the memory for continuously calculating the geographical coordinates of the receiver from the location information related to the geographical location of the receiver,
wherein the processing unit is further in communication with the camera and arranged to continuously analyze the visual information received from the camera and to relate it to the information indicative of the geographical location of the receiver.

17. A method comprising:
a) receiving location information related to the geographical location of a device for navigation assistance;
b) continuously receiving visual information registered by a camera;
c) displaying the visual information received
d) calculating the geographical coordinates of the device from the received location information related to the geographical location of the device, wherein the method further comprises:
e) continuously analyzing the visual information received and relating it to the calculated geographical location of the device.

18. A computer program for navigation assistance comprising instruction sets for:
a) continuously receiving location information related to the geographical location of a device for navigation assistance;
b) receiving visual information registered by a camera;
c) displaying the visual information received
d) calculating the geographical coordinates of the device from the received location information related to the geographical location of the device, wherein the method further comprises:
e) continuously analyzing the visual information received and relating it to the calculated geographical location of the device.
